(19) United States
(12) Patent Application Publication
(10) Pub. No.: US 2003/0209542 A1
(43) Pub. Date: Nov. 13, 2003

(54) Apparatus and method for microwave processing of food products

(76) Inventor: George M. Harris, Lewiston, ME (US)

Correspondence Address: DYKAS, SHAVER & NIPPER, LLP, P O BOX 877, BOISE, ID, 83701-0877, US

(21) Appl. No.: 10/145,641

(22) Filed: May 13, 2002

(51) Int. Cl. H05B 6/78

(52) U.S. Cl. 219/696; 219/700

(57) ABSTRACT

An apparatus, system, and method, for using circular mode magnetic microwave energy to heat the food product in a continuous microwave process. The microwaves are generated and transmitted as rectangular waveguide mode microwave energy, and are converted by mode converters to circular magnetic mode microwave energy. As circular magnetic mode microwave energy, the microwave energy passes through a food material and is reflected on the other side back into the food material, thus travelling through the food material a second time. Reflected microwave energy from the main reflected wave as well as reflections from other structures, surfaces and layers in the system travel back toward the microwave source. They are sensed, and a computer tuning system causes capacitive probes to generate offsetting microwave reflections, which are opposite in phase and equal in magnitude to the sum of all of the reflected waves. These induced reflections cancel and negate the reflected microwaves, resulting in optimum utilization of microwave energy to heat the food product.

### BACKGROUND OF THE INVENTION

Field of the Invention. This invention relates to an apparatus and a method for applying heat to food products.

Background. In various steps of food preparation processes, heat is applied to food for various reasons, and by various means. One common reason for heating food is simply to cook it, so that raw food enters at one end of the process and cooked food exits at the other end of the process. The heat for cooking food in this manner can come from a variety of sources, such as natural gas, electric heat, propane, or any number of fuel sources. Cooking of foods can also be accomplished by microwave energy, but it is difficult to apply microwave technology to a food process in order to achieve a continuous flow of product rather than batch operations. Conventional microwave technology operates in a batch configuration in which food is placed in a chamber, subjected to microwave energy, and then removed from the chamber to move to the next step of the process.

Heat is also applied to food products in order to facilitate other steps of processing and to lengthen the storage time of the foods. There is an enzyme in vegetables called the peroxidase enzyme. The peroxidase enzyme in foods causes vegetables to turn brown and prematurely lose shelf life. Before vegetables are dried, frozen, or canned, the peroxidase enzyme must be destroyed. This enzyme is fairly sensitive to heat, and if the vegetables are heated to an elevated temperature, the peroxidase enzyme will be destroyed and the vegetable will remain uncooked. The process of heating the vegetables sufficient to inactivate the peroxidase enzyme is called blanching.

One method for blanching is to inject steam into a covered auger in which the vegetables are being transported from one place to another. Vegetables can also be blanched by immersing them in boiling water for a short period of time. Conventional microwave processes are not conducive to blanching vegetables, because of the batch nature of the process, and because blanching requires a uniform elevation of temperature throughout the mass of vegetables. Conventional microwave technology often leaves hot and cold spots. The cold spots would contain the active peroxidase enzyme, and the hot spots would contain portions of vegetables which were cooked. Another form of microwave heating of foods for blanching is desirable, so that the energy efficiency of microwave can be applied to the steps of blanching and cooking foods.

Heat is also applied to foods in order to dehydrate the foods. This is typically accomplished by passing warm air over food pieces. The air picks up moisture from the food piece and carries it away, and gradually the food piece becomes dehydrated. The air passing over such food pieces can occur on a tray which forms a stack in a wind tunnel, or the drying can occur in bins with mesh bottoms which allow the passage of air, or by conveyor belts in which air passes through the conveyor belts and past the food, as well as by other means of heating. A continuous process utilizing microwave heating of foods for the purpose of drying is not practiced, but would be a desirable technology.

Accordingly, it is an object of the invention to provide a means by which food products can be uniformly heated by microwave energy in a continuous process. Another object of the invention is to provide a microwave heating system which heats food in a continuous process, and which utilizes a wide belt for conveying the food pieces.

It is the further object of the invention to provide a microwave food heating system which provides for maximum efficiency in the use of microwave energy.

It is the further object of this invention to be able to heat a moving mass of food product on a belt to a given uniform temperature, such that the heat is evenly distributed throughout the food product. According to the present invention, the foregoing and other objects and advantages are obtained by a system for heating food material in a continuous system in which food product is transported past a microwave energy source.

### DISCLOSURE OF INVENTION

According to the present invention, the foregoing and other objects and advantages are attained by a system for heating food through the use of microwave energy which passes through a food product, and is reflected back into the food product. The reflected wave is sensed, and tuned to cancel the reflected microwave energy for maximum efficiency. The food product would typically be arranged as a mass of food products on a conveyor belt, which passes through the microwave heating chamber of the invention. The food product is illuminated with a travelling wave of microwave energy which is absorbed by the food product as the microwave energy passes through the food product. The microwave energy is then reflected back into the food product, where more energy is absorbed as it passes all the way through the food product again, and the remaining microwave energy is sensed upon exiting the food product. The reflected energy from the incident wave and all other reflections from the food product are combined, and the combined reflected energy is measured by sensors. Tuners are used to generate an induced reflection which cancels the reflected energy. This system includes one or more microwave sources for illuminating and heating the food product before it exits the heating chamber. It also includes one or more wave guide networks for guiding a microwave travelling wave from the microwave source to the food product. The system also includes one or more mode converters which convert rectangular wave guide mode to circular magnetic mode microwave energy. The system also includes one or more circular magnetic mode microwave applicators. The system also includes microwave reflecting surfaces which are placed on the opposite side of the food product from the point of entry of the microwaves into the food product. The reflecting surfaces reflect the microwave travelling wave which exits an opposite side of the food product, directly back into the food product. The system also includes one or more sensors of microwave energy for measuring the microwave energy which is passed through the food product after being reflected, as well as other reflected microwave energy. These sensors of microwave energy report the energy measured to a computer tuning system. The system also includes a computer tuning system which uses the reported microwave energy which is measured by the sensors of microwave energy, to calculate adjustments required to reduce the amount of reflected microwaves passing back toward the microwave source to approximately zero. The system also includes a means of tuning the microwaves based on a signal from the computer tuning system.

This system can be designed so that the means for tuning the microwave generated is one or more capacitive probes which are activated by a signal from the computer tuning system and which allow the computer tuning system to control the phase of the applied microwave. The capacitive probes induce reflections which are opposite in phase and equal in magnitude to the reflected microwave energy. The system can utilize microwave reflecting structures to compensate for microwave reflections by other parts of the system.

In accordance with another aspect of the invention, the invention is an apparatus for generating heat in food products. The food product, as in the previous embodiment, is typically composed of individual pieces of food material which are grouped together on a moving conveyor belt which takes the food product through the heating chamber of the device. Heat is generated in the food product by illuminating the food product with a travelling wave of microwave energy which passes through the food product, is reflected back into the mass of the food product, is sensed, and is tuned to cancel reflected microwave energy.

This apparatus consists of one or more microwave sources for illuminating the food product, and one or more wave guide networks for guiding a microwave travelling wave from the microwave source to the food product. It also includes one or more mode converters which convert rectangular wave guide mode to circular magnetic mode microwave energy. It also consists of a number of circular magnetic mode microwave applicators. It also consists of microwave reflecting surfaces for reflecting the microwave travelling wave which is passed through a mass of food product, and exited an opposite side directly back into the food product. It also consists of one or more sensors of microwaves for measuring the microwave energy which is passed through the food product after having exited the food product and being reflected back into the food product. These sensors report the energy measured to a computer tuning system. The apparatus also includes a computer tuning system which uses a reported microwave energy which is measured by the sensors, to calculate adjustments required to reduce the amount of reflected microwaves passing back toward the microwave source to approximately zero.

The apparatus also includes a means for tuning the microwaves generated based on a signal from the computer tuning system. The apparatus for generating heat in a food product can be configured so that the microwave energy is applied normal to the longitudinal plane of the food product or parallel to the transverse access of the food product. The means of tuning the microwaves generated can be one or more capacitive probes which are activated by a signal from the computer tuning system.

Still another aspect of the invention is a method for generating heat in a food product. The food product is formed into a mass which has a center, a longitudinal and transverse axis. The method consists of illuminating the food product which is conveyed through a heating chamber by a conveying means, with a travelling wave of microwave energy from a microwave source which is conducted along a rectangular wave guide network as rectangular wave guide mode microwave energy, converting the microwave energy from the rectangular wave guide mode to circular magnetic mode using a mode converter; illuminating the food product with a travelling wave of circular magnetic mode microwave energy; reflecting the travelling wave of microwave energy back into the food product after it has passed through the food product; sensing the reflected microwave energy which travels toward the source of microwave energy; using tuning probes to cancel the reflected microwave energy by induced reflections of an opposite phase in equal magnitude; passing the food product through the microwave energy field in a continuous motion.

This method utilizes microwave sensors which are located in the wave guide. The microwave energy is tuned by inducing reflections by the use of tuning probes which equal and cancel the reflected microwave energy. Using circular magnetic mode microwaves can be the sole source of heat in a system, or it can be used in conjunction with supplemental heat which is applied to the food product at various points of its processing.

The method and apparatus of the invention, using microwave energy which passes through the food product, is reflected back into the food product, is sensed, and the microwave energy tuned to reduce the reflected microwave energy to approximately zero, thus optimizes the use of energy in heating a food product. Since the microwave energy is applied by a number of microwave applicators normal to the longitudinal plane of the mass of food product on a conveyor belt, a conveyor belt with food product on it of any width can be accommodated. Since the energy is applied through a number of tuning systems which are being continually adjusted for optimal energy delivery as the food product travels through the microwave heating apparatus, this apparatus accounts for variations in density, moisture content of the food product, and other variables in the food product to deliver a uniform distribution of heat to the food product.

Still other objects and advantages of the present invention will become readily apparent to those skilled in this art from the following detailed description, wherein I have shown and described only the preferred embodiment of the invention, simply by way of illustration of the best mode contemplated by me of carrying out my invention. As will be realized, the invention is capable of modifications in various obvious respects, all without departing from the invention. Accordingly, the drawings and descriptions are to be regarded as illustrative in nature, and not as restrictive.

### BRIEF DESCRIPTION OF THE DRAWINGS

FIG. 1 is a prospective view of a prior art food heating device for heating food by the application of hot air.

FIG. 2 is a side cross-sectional view of a sensing section of the invention.

FIG. 3 is a side cross-sectional view of a tuning section of this invention.

FIG. 4 is a side cross-sectional view of a tuning probe of the invention.

FIG. 5 is a perspective cross-sectional view of a microwave source, wave guide, microwave applicator, and food product in a heating chamber of the invention.

FIG. 6 is a cross-sectional perspective view of the heating chamber of the invention showing field stop mechanisms.

FIG. 7 is a cross-sectional side view of the heating chamber of the invention.

FIG. 8 is a perspective view of the microwave applicator showing its heat distribution pattern on a mass of food product on a conveyor belt below the microwave applicator.

FIG. 9. is a top view of six microwave applicators showing the interaction of their heating tracks.

FIG. 10 is a schematic showing the tuning system of the invention.

FIG. 11 is a cross-sectional view of a signal direction sensor of the invention.

### BEST MODE FOR CARRYING OUT THE INVENTION

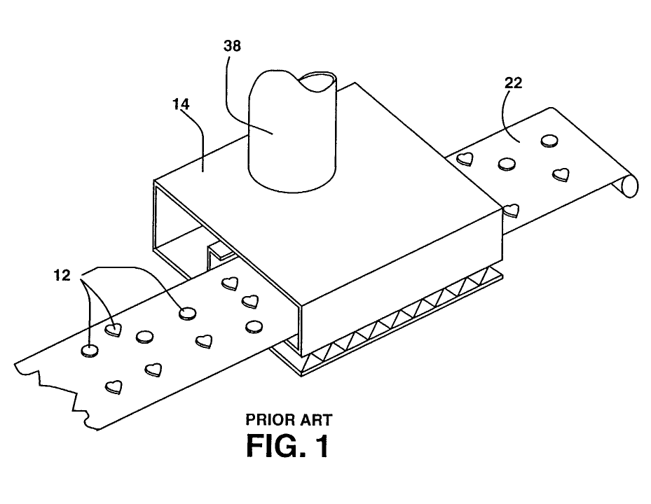

Referring to FIGS. 1 through 12, the invention is shown to advantage. FIG. 1 shows a simplified view of a prior art system for cooking or heating foods on a conveyor belt. The food product 12 is shown as a mass of small pieces of food product, such as apple slices or vegetable pieces. However, the food product 12 could be of any type of food, any piece size, and the conveyor belt could be a number of different widths. In one configuration of the prior art system, the food product 12 could be diced carrots which are subjected to steam in order to blanch the carrots. Blanching is a step in the processing of vegetables in which enough heat is applied to the vegetables to deactivate the peroxidase enzyme, but the vegetable piece remains uncooked. Blanching is common for drying, freezing or canning of many types of vegetables. The food product enters the heating machinery 14, which consists of a continuous belt 22. The food product 12 is carried through the heating machinery 14 on the continuous belt 22, and exits the heating machinery 14 after the food product 12 has been sufficiently heated. While the food product 12 is in the heating machinery 14, heat is applied from a heat source 38, and is directed onto or through the food product 12. The heat can be in the form of steam, combustion gases from propane or natural gas burners, or hot air. The heat energy heats the food product 12 and carries out the desired step of cooking, warming, blanching, or dehydrating.

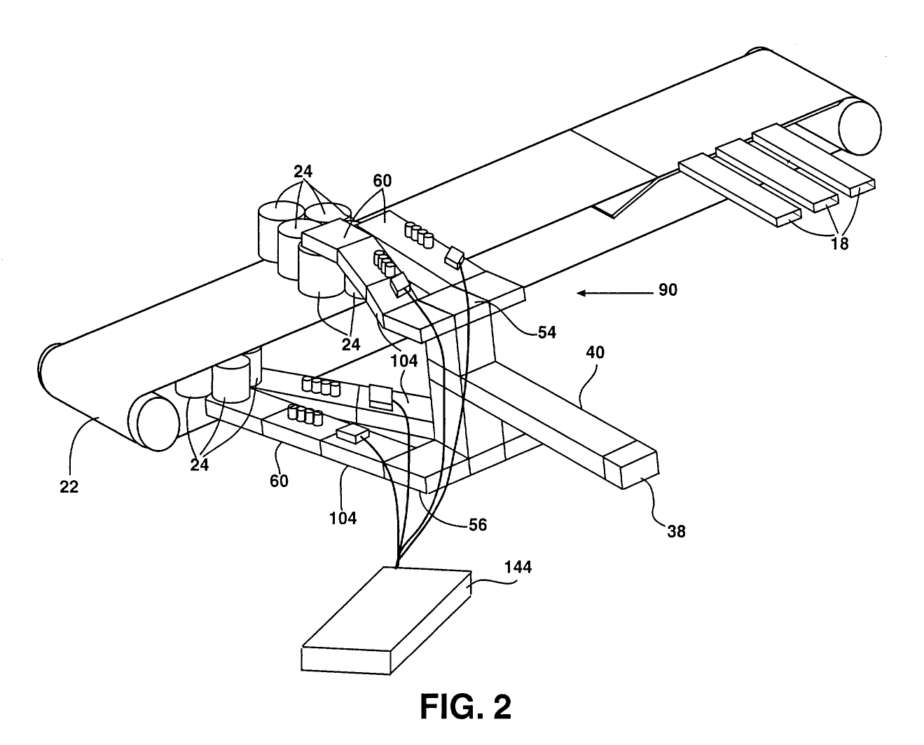

FIG. 2 shows a simplified view of the invention. The system for heating food includes a microwave source 38, wave guide straight sections 40, wave guide elbows 56, and wave guide tees 54. These wave guide components can be of any conductive material, but will typically be of aluminum. These comprise a wave guide network 90 which utilizes conventional technology components to carry microwave energy in the form of rectangular waveguide mode microwave energy from the microwave source 38 to applicators 24. Each wave guide source 38 supplies energy through a wave guide network 90 to a pair of applicators 24 above the heating chamber 34 and a pair of applicators below the heating chamber 34. Thus, three microwave sources 38 would be required to energize 12 applicators 24. Other configurations of microwave sources 38 to applicators 24 are of course possible while practicing the invention.

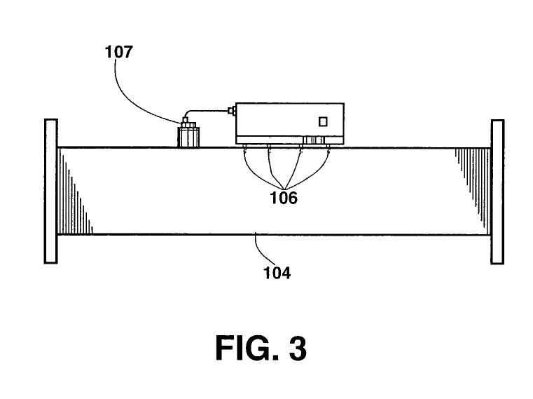

Incorporated into the wave guide network 90 is a sensor section 104 and a signal directional sensor 107. Each sensor section 104 contains four microwave sensors 106, as shown in FIG. 3. These are conventional technology sensors. They generate a signal which is routed to a computer 108, which in the best mode of the invention is mounted on sensor section 104. The sensors 106 are placed in the sensor section 104 such that the reflection phase displacement along the wave guide is 90 degrees in reflection.

Signal direction sensor 107 is described in U.S. Pat. No. 5,756,975, which is incorporated herein by reference.

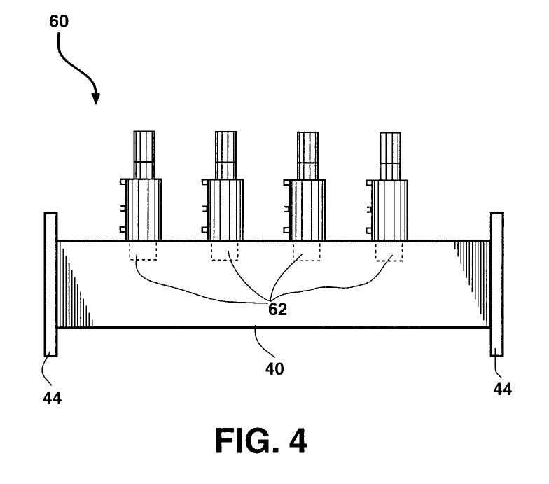

Mounted on the opposite side of the sensor section 104 from the microwave source 38 is a tuner section 60. Tuner section 60 includes four field divergent capacitive probes 62, which will be hereinafter referred to as tuning probes 62, which are spaced 8.06 inches apart. FIG. 4 shows tuning section 60 and tuning probes 62. In one preferred embodiment, tuning section 60 is 54 inches long. Tuning probes 62 extend 0-3 inches into tuning section 60. Tuning probes 62 are made of silver plated brass.

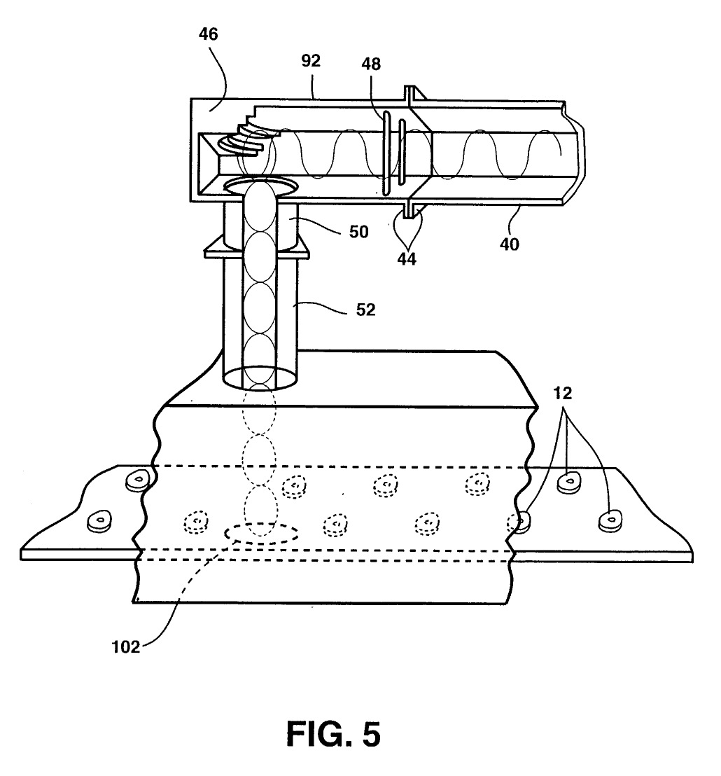

After the tuning section 60, the wave guide straight sections 40 attach by flanges 44 to a mode converter section 92. The interior detail of mode converter section 92 is shown in FIG. 5. Within the mode converter section 92 are located compensating structures 48, which are cylindrical structures typically of aluminum, though other conductive material is also suitable. Also within mode converter section 92 is located circular magnetic mode converter 46, which will be referred to as mode converter 46. Mode converter 46 is a three stepped structure, with each step having a curved surface. In one preferred embodiment, the mode converter 46 is 9.75 inches wide, and 4.88 inches tall. Each step is 1.62 inches in height, with a 5.5 inch radius to the curve. Directly below mode converter 46 and attached to mode converter section 92 is an output section 50. This in turn is attached to circular section field formation tube 52. In this preferred embodiment, circular section field formation tube 52 is 40 inches tall and like output section 50, is 11 inches in diameter. Circular section field formation tube 52 is in turn attached to heating chamber 34. In one preferred embodiment, at the interface of circular section field formation tube 52 and heating section 34 is a Teflon® window 58. Each circular section field formation tube when joined to an output section 50 comprises an applicator 24.

Heating chamber 34, shown in FIG. 5, is a generally rectangular chamber through which the food product 12 passes.

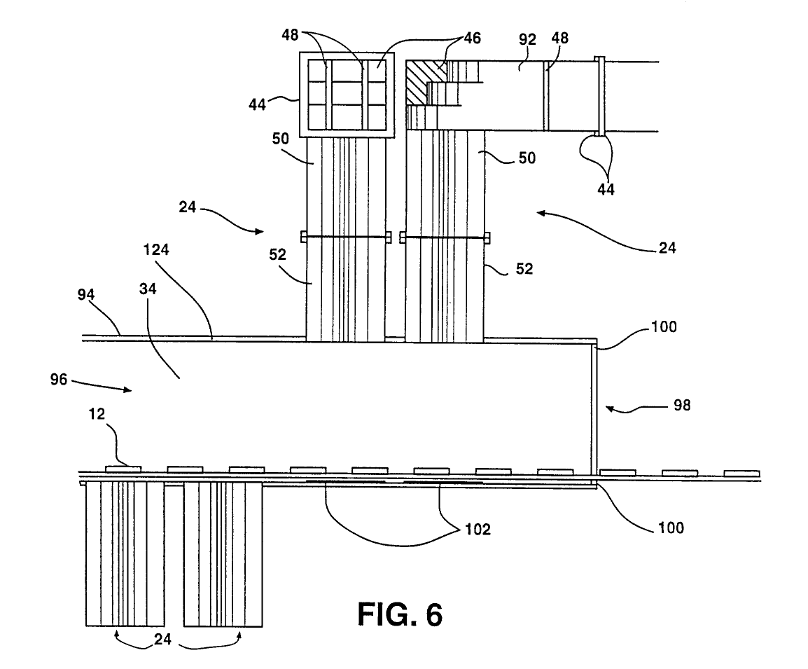

Heating chamber 34 is surrounded by a water tank 94 shown in FIG. 6, which serves as an absorber of microwave energy which is scattered from the heating chamber 34. Water tank 94 is filled with a water solution which is routed to a radiator (not shown). Heating chamber 34 has a first aperture 96 through which food product 12 enters the heating chamber 34. Heating chamber 34 also has a second aperture 98 through which food product 12 exits the heating chamber. Surrounding the first and second apertures 96 and 98 are three quarter wave guide wavelength wave traps 100. These are generally rectangular sections which are open on the side facing the food product 12, but which are closed on all other sides. Each wave trap 100 is short circuited at a distance equaling three quarter wave guide wavelength from the open end.

On the side of the heating chamber 34 opposite each applicator 24 is a reflecting surface 102. This is a flat surface which reflects microwave energy. Other preferred embodiments of the invention utilize reflecting surfaces which are curved to focus or diffuse microwave energy, or which are adjustable in position and shape.

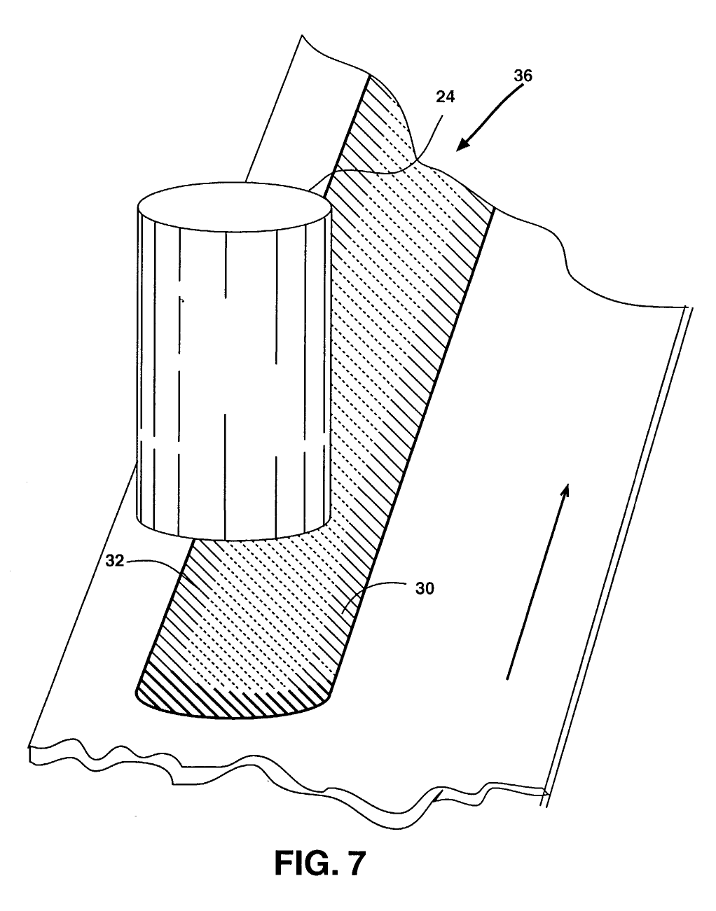

In operation, a food product 12 is placed on a moving conveyor belt which moves the food product 12 into the heating chamber. The continuous belt is transparent to microwave energy. As the food product 12 passes in a continuous motion through heating chamber 34, microwave energy is directed through the food product 12 from above and below, as shown in FIG. 3. This microwave energy originates from a number of microwave sources 38, preferably one microwave source for each four applicators 24. The microwave energy passes through a wave guide network 90, through sensor section 104 and through tuner section 60, and reaches mode converter section 92, shown in further detail in FIG. 7. Within mode converter section 92, the microwave energy encounters mode converter 46, which converts the microwave energy from rectangular waveguide mode (TE₁₀) to circular magnetic mode (TM₀₁) microwave energy. Although the best utilizes circular magnetic mode energy to heat the food product 12, other modes of microwave energy are possible for use by this system. These other modes could include an evanescent field. Inherent in the encounter of microwave energy with mode converter 46, reflections of microwave energy occur, and these reflections travel back toward the microwave source 38. These are canceled out by equal and opposite wave patterns set up in the microwave path by compensating structures 48.

After exiting the mode converter section 92, the microwave energy travels through the output section 50 and into the circular section field formation tube 52. The output section 50 acts as a Fresnel field suppression section. This section allows the Fresnel fields that are high in strength in the direct vicinity of the mode converter 46 to fall off as the microwaves, now in the new symmetrical circular magnetic mode, travel toward the heating chamber 34. As it exits the circular section field formation tube 52, the microwave energy enters the heating chamber 34 in a circular magnetic mode. In this mode, the microwave energy enters the heating chamber 34 and the food product 12 within the heating chamber 34 as an incident wave with two separate electric field components that are oscillating at the operating microwave frequency. This exposes the food product 12 to electric fields in two axes, one axial, or along the axis of travel of the incoming microwave signal, and one radial, from the center of the applicator 24.

This system exposes the food product 12 to a system of fields that are highly efficient in converting the energy of the microwaves into heat, which is produced in the food product. Further, since this microwave energy is directed normal to the longitudinal axis of the food product 12, the width of a food product 12 is not limited by the limits of penetration of microwave energy from the side of the food product. FIG. 6 shows the arrangement of banks of applicators 24 above and below the food product 12. The applicators 24 positioned above the food product 12 in FIG. 6 show a cross section and an end view of the mode converter section 92. FIG. 7 shows the heating track 36 which results from a food product 12 moving through the outer heating zone 30 and the inner heating zone 32 which is projected from applicator 24. Any number of sizes and configurations of food product are equally well suited for use with this system. FIG. 11 shows the heating tracks 36 on food product 12 which result from a bank of six applicators 24. In one preferred mode, the applicators 24 are spaced with their center point 8.57 inches apart, with a first group of three applicators 24 set with centers 15 inches from the centers of another group of three. The first group of three applicators 24 are spaced with their centers 7-1/2 inches from the end of the heating chamber 34, which itself is 60 inches wide. A similar bank would be positioned on the opposite side of the food product. In the best mode of the invention, the maximum width of a food product 12 would be slightly narrower than the outside edges of the outside applicators 24. Although a bank of six applicators is shown, there is no limitation on the number of applicators which could be used. To heat a wider mass of food product 12, banks of 8, 10 or more applicators are possible.

As the incident microwave energy from the applicator 24 passes through the food product 12, some is absorbed in the food product 12 and some passes through the food product 12. The microwave energy which passes through the food product 12 strikes a reflecting surface 102 mounted below the food product 12 which can be on the inside surface of the bottom surface of the heating chamber 34, as shown in FIG. 6. The reflecting surface 102 reflects the incident microwave energy directly back into the food product 12 as a reflected wave, where it again passes through the food product. The incident and reflected waves form a standing wave located within the food product 12, and heat the water within the food product. The superposition of the incident and reflected waves results in an interference pattern of standing waves that are positioned in between the applicator 24 and the reflecting surface 102. This pattern of standing waves will result in increased electric field strength inside the food product 12 assembly due to the electric field vectors, one incident from the applicator 24 and the other launched from the reflecting surface 102, adding constructively. Maximum loss, and hence, best microwave match to the food product 12 assembly will occur when maximum electric field is present where the high microwave losses are, which is at the center of the food product 12.

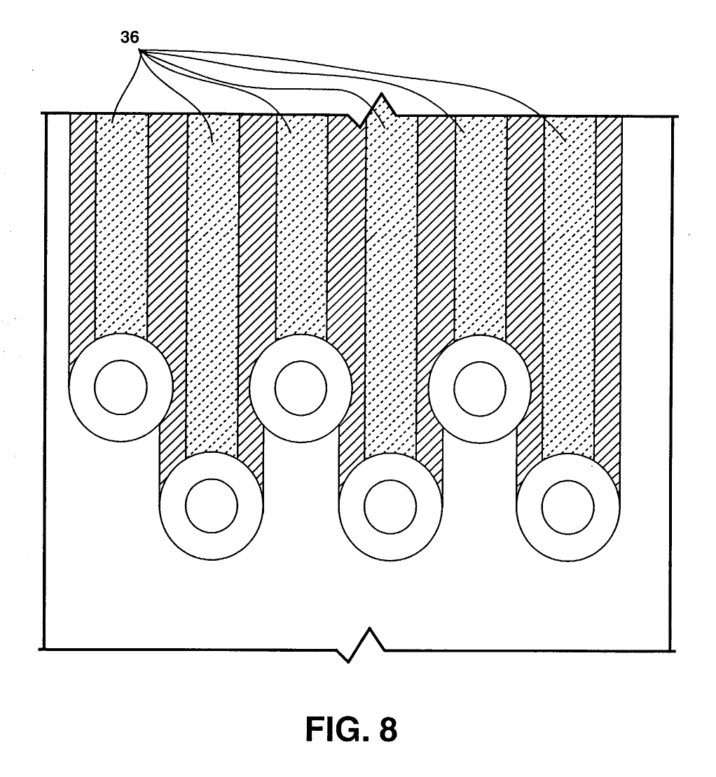

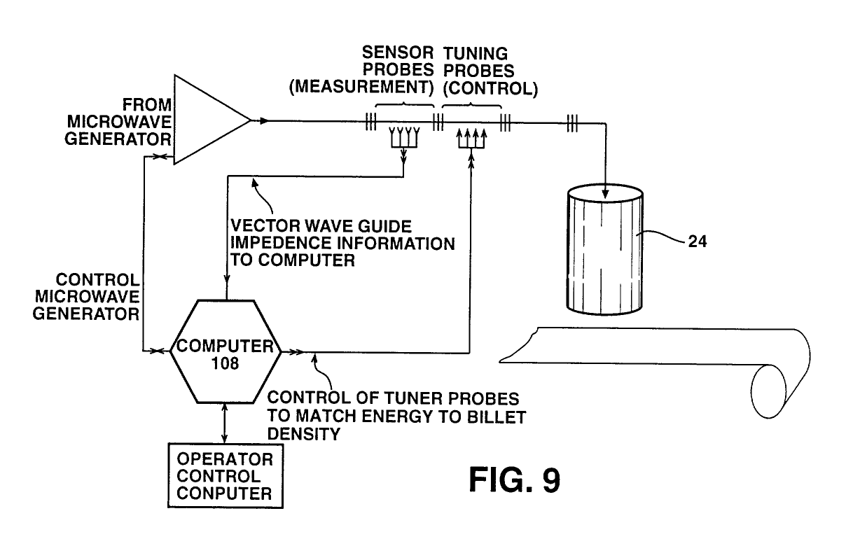

As the incident microwave energy exits the applicator 24, is passes through a number of surfaces which cause reflections. The first is a plane encountered when the microwave energy enters the heating chamber 34. The next reflection surface is the first layer of the food product 12, whatever shape that might be. Each subsequent layer of food product surface causes further reflections, and each reflection wave itself results in smaller reflections as they pass through the food product. Since each of these reflected waves has an associated magnitude and phase, which is the microwave equivalent of strength and direction, the reflections combine vectorally and either add to each other or cancel each other out. The summed reflection wave from all the reflection surfaces, including the reflected wave which resulted from the incident wave passing through the food product and being reflected from the reflecting surface, travels back through the applicator 24, through the mode converter section 92, and through the tuning section 60 and into the sensor section 104 in a direction opposite to that of the incident wave. This summed reflected wave is sensed and tuned as shown in schematic in FIG. 9. Since each applicator 24 has its own sensing section 104 and tuning section 60, each applicator can be individually and independently tuned to adjust to changes in reflections caused by changing density of food product under a particular applicator.

In the sensor section 104 the sensor probes 106 detect the phase and magnitude of reflected microwave radiation reaching the sensor section 104. The sensor probes 106 are placed in the sensor section 104 such that the reflection phase displacement along the wave guide is 90 degrees in reflection. These sensors provide complete vector representation. The sensor probes 106 are spaced exactly one-eighth wave guide wavelength at the operating frequency of the system. Information from all four sensor probes 106 is sent to computer 108. The computer 108 uses input from the four sensor probes 106 to determine the vector reflection coefficient.

Based on this information calculated individually for each applicator 24, the computer 108 calculates the needed phase and magnitude needed to completely counteract the reflected energy, and sends a signal to the tuner probes to extend into or retract from the tuning sections 60. As the tuning probe 62 is extended into the tuning section 60, it introduces capacitive discontinuities, which could also be called an induced reflection. Since the tuning probes 62 are also spaced at 90 degrees phase displacement at the center operating frequency, their adjustment can result in setting up a standing wave pattern that will result in an induced reflection which will sum with all the other reflections and cancel them out. The induced microwave reflection is opposite in phase and equal in magnitude to the reflected microwaves. In this way the reflected energy is eliminated, and all the energy of the microwave is utilized to heat the food product 12. Due to real time adjustments of the induced reflection, irregularities in the density of the food product, its water content, and its composition are compensated for, and uniform and efficient heating is achieved and maintained. This allows for uniform heating throughout the food product and heating to the precise temperature desired.

An additional benefit in the use of the sensing system is the option of its use as a quality monitor. Any sudden change in sensed data would alert the operator to a condition which should be investigated. A computer 144 is provided for this purpose. Computer 144 connects to each computer 108 on each sensing section 104 by optic fiber cable.

Between the microwave source 38 and the sensors 106 is located a signal direction sensor 107, which is shown in FIG. 13. This device is built to sense microwave power levels coming from one direction only, and senses the power level coming from the microwave source 38. The loop 132 of the signal direction sensor 107 senses both electric and magnetic waves from the microwave signals in the waveguide. These signals combine as vectors at both ends of the loop. The vectors are equal in magnitude and opposite in direction at one end of the loop, and equal in magnitude and equal in direction at the other, depending on the direction of travel of the microwaves in the waveguide that the sensor is connected to. The signals that are in the unwanted direction, from the heating chamber 34, are diverted. The signals that are in the desired direction, from the microwave source 38, are sensed and reported to the computer. The computer uses the sensed power level of the microwave source 38 as one piece of information to use in calculating the tuning signals which are required for the tuning probes 62. Since the signal direction sensor 107 is sensitive to the flow of microwave energy in one direction only, it is not affected by the interference pattern of standing waves created by the superposition of the two waves traveling in opposite directions.

Some of the microwave energy which enters the heating chamber 34 is reflected away from the food product. Three mechanisms are in place to prevent the escape of any of these reflected microwaves. As shown FIG. 6, the heating chamber 34 is surrounded by a water tank 94. The walls of the water tank 94 are of a material which is transparent to microwave energy, such as high density polyethylene. The fluid 124 in water tank 94 is an aqueous solution preferably containing propylene or ethylene glycol. The fluid 124 in the water tank 94 is routed to a conventional radiator (not shown), to dissipate any heat which is generated in the fluid 124.

In addition to the water tank 94 filled with fluid 124 surrounding heating chamber 34, around the first aperture 96 to the heating chamber and the second aperture 98 to the heating chamber are located three-quarter wave guide wavelength traps 100. These are also shown in FIG. 6. These wave guide traps are provided to allow the electric fields in the trapped sections to fully form, so that an appropriate field profile from the trap is presented to the heating chamber 34 fields so as to stop the electric fields from exiting the heating chamber 34. By these three devices: the water tank 94, and the wave traps 100 at either end of the heating chamber 34, escape of unwanted amounts of microwave energy from the device is prevented.

The food product 12 is heated in the heating chamber 34 to the temperature desired. This can be a different temperature, if the purpose of the process is to cook the food, blanch the food, or dehydrate the food. In the case of dehydration, supplemental air may be passed through or around the food product 12 to carry away moisture and assist in the dehydration of the food product 12.

In accordance with the best mode contemplated for the application of this invention, assemblies of food product are heated using microwave energy in a continuous stream.

The system can be used to blanch vegetables such as carrots, corn, green beans, and potatoes, and other vegetables. It can also be used to dehydrate food products such as sliced apples, diced apples, carrot pieces, green beans, corn, potatoes, and other fruits and vegetables. The device can also be used to cook dough or breaded foods, pizza, meats, soups and stews, or other kinds of cooked foods. Although a nominal width of 4 feet is anticipated, it is planned that the apparatus and method will accommodate belts carrying food products 8 feet in width or larger. The width of the food product is determined by the width of the belt, and is not anticipated to be a limitation of this system.

A microwave energy source for this invention is a conventional microwave power source. The power output is nominally 75 kWh for each transmitter used by the system. The current design of the system calls for three microwave sources 38 and twelve applicators 24 to be utilized.

While there is shown and described the present preferred embodiment of the invention, it is to be distinctly understood that this invention is not limited thereto but may be variously embodied to practice within the scope of the following claims.

I claim:

1. A system for heating food by illuminating food products with an incident traveling wave of microwave energy which passes through the food product, is reflected back through the food product as a reflected wave, the reflected wave is sensed, and tuned to cancel a reflected microwave energy, said system comprising:
a means for moving food through a microwave energy field;
a plurality of microwave sources for generating microwave energy;
a wave guide network for guiding a microwave traveling wave from the microwave source to a food product as a rectangular waveguide mode;
a plurality of mode converters which convert rectangular waveguide mode to a form of microwave energy called circular magnetic mode microwave energy;
a plurality of circular magnetic mode microwave applicators;
a heating chamber for heating food with circular magnetic mode microwave energy; a plurality of microwave reflecting surfaces for sending a reflected microwave energy wave which exits an opposite side of the food product directly back into the food product;
a plurality of sensors of microwave energy for measuring reflected microwave energy which is traveling toward the microwave source, and for reporting energy as reported microwave energy measured to a computer tuning system; a computer tuning system which uses the reported microwave energy measured by the sensors of microwave energy to calculate adjustments required to reduce the reflected microwaves traveling toward the microwave source to approximately zero; and
a means for tuning the microwaves based on a plurality of control signals from the computer tuning system.

2. The system for heating food of claim 1, wherein the means for tuning the microwaves generated is a plurality of capacitive probes which are activated by a plurality of signals from the computer tuning system and which are positioned to decrease or increase an intentionally induced microwave reflection and thus cancel the reflected microwave.

3. The system for heating of food of claim 1 which further comprises application of microwave energy to the food product normal to the longitudinal axis of the food product.

4. The system for heating food of claim 1 which includes microwave reflecting structures which compensate for microwave reflections.

5. The system for heating food of claim 1 in which the microwave reflecting surfaces can be variably adjusted to focus the microwave energy being reflected, to diffuse the microwave energy being reflected, or to simply reflect the microwave energy being reflected.

6. The system for heating food of claim 3 which further comprise stepper motors for adjustment of the capacitive probes.

7. The system for heating of claim 1 which further comprises a computer for displaying process parameters.

8. An apparatus for generating heat in a mass of food product, in which the food product is conveyed, the mass of food product having a longitudinal axis and a transverse axis, and the heat is generated by illuminating the mass of food product with a traveling wave of microwave energy which passes through the food product, is reflected back into the food product, is sensed, and is tuned to cancel a reflected microwave energy, the apparatus comprising:
a means for conveying said mass of food product;
a plurality of microwave sources for generating microwave energy;
a wave guide network for guiding a microwave traveling wave from the microwave source to the food product;
a plurality of mode converters which convert rectangular waveguide mode to circular magnetic mode microwave energy;
a plurality of circular magnetic mode microwave applicators;
a heating chamber through which food product passes and where microwave energy is applied in the form of circular magnetic mode microwave energy;
microwave reflecting surfaces for reflecting the microwave traveling wave which exits an opposite side of the food product directly back into the food product;
a plurality of sensors of microwaves for measuring the reflected microwave energy which has passed through the food product after exiting the food product and being reflected back into the food product, as well as other reflected microwave energy, and for reporting the reflected microwave energy measured to a computer tuning system;
a computer tuning system which uses the reported microwave energy measured by the sensors to calculate adjustments required to reduce the amount of reflected microwaves passing toward the microwave source to approximately zero; and
a means for tuning the microwaves generated based on a plurality of control signals from the computer tuning system.

9. The apparatus for generating heat in a mass of food product of claim 8 which further comprises application of microwave energy to the food product normal to the longitudinal axis of the food product.

10. The apparatus for generating heat in a mass of food product of claim 8 which further comprises application of microwave energy to the food product parallel to the transverse axis of the food product.

11. The apparatus for generating heat in a mass of food product of claim 8, wherein the means for tuning the microwaves generated is a plurality of capacitive probes which are activated by a plurality of signals from the computer tuner system, and which are moved by stepper motors.

12. The apparatus for producing heat in a mass of food product of claim 8 in which the microwave energy applied to the food product is in the form of evanescent field.

13. The apparatus for producing heat in a mass of food product of claim 8 which further comprises a computer for displaying process parameters.

14. A method for generating heat in a food product, in which the method comprises:
conveying food product into a microwave field for heating;
generating microwave energy from a microwave source;
conducting the microwave energy through a rectangular microwave wave guide network as rectangular waveguide mode microwave energy;
converting the microwave energy from rectangular waveguide mode to circular magnetic mode using a mode converter;
illuminating the food product with a traveling wave of circular magnetic mode microwave energy;
reflecting the traveling wave of microwave energy back into the food product after it has passed through the food product;
sensing the reflected microwave energy which travels toward the source of the microwave energy;
tuning the microwave energy so that the reflected microwave energy is canceled by induced reflections of an opposite and equal nature; and
passing the food product through the microwave energy field in a continuous motion.

15. The method of claim 14 in which sensing is accomplished by a plurality of sensors located in the rectangular wave guide network.

16. The method of claim 14 in which tuning is accomplished by using probes which induce microwave reflections which equal and cancel the reflected microwave energy from the heating chamber.

17. The method of claim 14 in which illuminating the food product with the microwave energy is done in a preheating stage by applying microwave energy which is in a form other than rectangular waveguide mode, such as evanescent field.

18. The method of claim 14 which further comprises displaying process parameters using a computer.
